(19) United States
(12) Patent Application Publication
(10) Pub. No.: US 2025/0083685 A1
(43) Pub. Date: Mar. 13, 2025

(54) AUTONOMOUS DRIVING VEHICLE AND CONTROL METHOD THEREOF

(71) Applicants: HYUNDAI MOTOR COMPANY, Seoul (KR); KIA CORPORATION, Seoul (KR)

(72) Inventor: Jun Hyung Song, Hwaseong-si (KR)

(73) Assignees: HYUNDAI MOTOR COMPANY, Seoul (KR); KIA CORPORATION, Seoul (KR)

(21) Appl. No.: 18/825,201

(22) Filed: Sep. 5, 2024

(30) Foreign Application Priority Data
Sep. 8, 2023 (KR) 10-2023-0119577

(51) Int. Cl. B60W 50/14; B60W 30/12; B60W 30/16; B60W 40/08; B60W 50/00; B60W 60/00

(52) U.S. Cl. CPC B60W 50/14; B60W 30/12; B60W 30/16; B60W 40/08; B60W 60/001; B60W 2040/0818; B60W 2050/0083; B60W 2050/146; B60W 2540/229; B60W 2552/30; B60W 2552/53; B60W 2554/80

(57) ABSTRACT

A method of controlling an autonomous vehicle including a processor includes under control of the processor, sensing an operation state of an autonomous driving function, setting a driver's driving state criterion differently based on a result of the sensing, determining a driver inattention state based on the driver's driving state criterion, and displaying, on an instrument cluster, a result of the determining.

### CROSS-REFERENCE TO RELATED APPLICATION

This application claims priority to and the benefit of Korean Patent Application No. 10-2023-0119577, filed on Sep. 8, 2023, the entire content of which is hereby incorporated by reference.

### BACKGROUND

### Technical Field

The present disclosure relates to an autonomous vehicle and a control method thereof and, more particularly, to an autonomous vehicle and a control method thereof that may establish comprehensive determination criteria.

### Discussion of Related Art

Autonomous vehicles, which may reduce driver fatigue by performing driving, braking, and steering on behalf of drivers, are recently required to have the ability to adaptively respond to surrounding situations that change in real time while driving.

To mass produce autonomous vehicles and to promote the use of the autonomous vehicles, a reliable determination control function may be required above all. For example, recent commercial vehicles are equipped with various functions, such as, for example: a highway driving assist (HAD) function; a driver state warning (DSW) function that determines drowsy driving, distracted gaze, and driver's carelessness (or inattention) and abnormal conditions and outputs a warning alarm through a cluster and the like; a driver attention warning (DAW) function that checks whether a vehicle drives unsafely by crossing lanes using a front camera; and a forward collision-avoidance assist (FCA) function or active emergency braking system (AEBS) that performs sudden braking when a forward collision is detected.

The DAW function may detect driving patterns, such as, for example, longitudinal acceleration/deceleration driving patterns, lateral displacement size, steering torque, lateral jerk, and lane departure, using a front camera, to determine a driving level that requires caution or attention.

For example, when a driver has a driving habit of making sharp longitudinal/lateral adjustments, a driver attention warning function may be activated unnecessarily, reducing its functional usability even in a normal attention state of the driver.

In addition, when a driver is driving in reliance on an autonomous driving function, a driving pattern of the driver may not be readily determined because the driving is normally controlled, overall, without a significant change in a driving environment in both longitudinal and lateral directions of a vehicle.

The statements in this Background section merely provide background information related to the present disclosure and may not constitute prior art.

### SUMMARY

Objects of the present disclosure are to provide an autonomous vehicle and a control method that may determine a driver's driving attention state using an autonomous driving function.

Objects of the present disclosure are also to provide an autonomous vehicle and a control method that may establish comprehensive determination criteria by recognizing situations where warning or control operations of an autonomous driving function operate and that may warn a driver of a determined driving attention state.

The technical objects to be achieved by the present disclosure are not limited to those described above. Other technical objects not described above may also be more clearly understood by those having ordinary skill in the art from the following description.

To solve the preceding technical problems, according to an embodiment of the present disclosure, a method of controlling an autonomous vehicle having a processor is provided. The method includes, under control of the processor: sensing an operation state of an autonomous driving function; setting a driver's driving state criterion based on a result of the sensing; determining a driver inattention state based on the driver's driving state criterion; and displaying, on an instrument cluster, a result of the determining.

In at least one embodiment of the present disclosure, the method includes, under the control of the processor, in response to the autonomous driving function not being in an on state (e.g., in response to deactivation of the autonomous driving function, or when the autonomous driving function is deactivated), recognizing a relative distance to a front vehicle travelling ahead of the autonomous vehicle or a vehicle travelling behind the autonomous vehicle in another lane and recognizing a distance to a lane line while maintaining the autonomous driving function in a ready state.

In at least one embodiment of the present disclosure, setting the driver's driving state criterion includes: in response to the autonomous driving function being in the on state (e.g., in response to activation of the autonomous driving function, or when the autonomous driving function is activated), setting the driver's driving state criterion to a first driver driving state criterion; or in response to the autonomous driving function not being in the on state, setting the driver's driving state criterion to a second driver driving state criterion.

In at least one embodiment of the present disclosure, the autonomous driving function includes a forward collision-avoidance assist (FCA) function, a lane keeping assist (LKA) function, a blind-spot collision-avoidance assist (BCA) function, a smart cruise control (SCC) function, or a lane following assist (LFA) function. The first driver driving state criterion includes at least one of: whether a warning or control occurs by the FCA function, the BCA function, or the LKA function due to the driver changing a movement direction or speed of the autonomous vehicle while the FCA function, the BCA function, or the LKA function is operating; whether the SCC function is canceled due to the driver controlling a brake pedal over a preset reference brake range while the SCC function is operating; or whether the LFA function is canceled due to the driver controlling steering over a preset reference steering range while the LFA function is operating.

In at least one embodiment of the present disclosure, the second driver driving state criterion includes at least one of: a criterion of the FCA function, the BCA function, or the LKA function to initiate warning or controlling to perform the corresponding function; a criterion of the LFA function to initiate controlling to keep a center of the lane on a road; or a criterion of the SCC function to initiate controlling to maintain a distance to a vehicle ahead.

In at least one embodiment of the present disclosure, the criterion of the LFA function to initiate controlling to keep the center of the lane includes one of: whether the autonomous vehicle makes a sharp turn with steering that is greater than a curvature of a straight or curved road on which the autonomous vehicle is driving; whether, while driving with steering less than a curvature of a curved road on which the autonomous vehicle is driving, the autonomous vehicle changes the steering to greater steering; or whether, although the autonomous vehicle is positioned at the center of the lane, the driver steers a number of times over a preset reference number (e.g., the driver steers more often than a preset reference number of steering occurrences).

In at least one embodiment of the present disclosure, the criterion of the SCC function to initiate controlling to maintain the distance to the vehicle ahead of the autonomous vehicle includes one of: whether a deviation of a maintained distance to the vehicle ahead is greater than a preset value; whether the autonomous vehicle decelerates with a deceleration greater than a preset value even in the absence of the vehicle ahead; or whether the autonomous vehicle decelerates with the deceleration in a situation where the distance to the vehicle ahead is greater than a preset maintained distance and there is no change in acceleration of the vehicle ahead.

In at least one embodiment of the present disclosure, determining the driver inattention state includes, under the control of the processor: in response to departing from the first driver driving state criterion or the second driver driving state criterion, calculating an inattentive driving score; accumulating the calculated inattentive driving score; and applying the accumulated inattentive driving score to a plurality of preset reference risk levels to determine the driver inattention state.

In at least one embodiment of the present disclosure, determining the driver inattention state further includes, under the control of the processor, in response to not departing from the first driver driving state criterion or the second driver driving state criterion during a preset reference driving time, decreasing by a score from the accumulated inattentive driving score.

According to an embodiment of the present disclosure, a non-transitory computer-readable storage medium stores instructions that are executable by the processor to perform a method of controlling the autonomous vehicle, such as the aforementioned method embodiments.

To solve the preceding technical problems, according to another embodiment of the present disclosure, an autonomous vehicle is provided and includes a processor. The processor is configured to sense an operation state of an autonomous driving function, set a driver's driving state criterion based on a result of the sensing, determine a driver inattention state based on the set driver's driving state criterion, and display, on an instrument cluster, a result of the determining.

In a vehicle of at least one embodiment of the present disclosure, the processor is further configured to, when the autonomous driving function is not in an on state, recognize a relative distance to a front vehicle travelling ahead or a vehicle travelling behind in another lane and a distance to a lane line while maintaining the autonomous driving function in a ready state.

In a vehicle of at least one embodiment of the present disclosure, the processor is further configured to, in response to the autonomous driving function being in the on state, set the driver's driving state criterion to a first driver driving state criterion, or, in response to the autonomous driving function not being in the on state, set the driver's driving state criterion to a second driver driving state criterion.

In a vehicle of at least one embodiment of the present disclosure, the autonomous driving function includes a forward collision-avoidance assist (FCA) function, a lane keeping assist (LKA) function, a blind-spot collision-avoidance assist (BCA) function, a smart cruise control (SCC) function, or a lane following assist (LFA) function. The first driver driving state criterion includes one of: whether a warning or control occurs by the FCA function, the BCA function, or the LKA function due to the driver changing a movement direction or speed of the autonomous vehicle while the FCA function, the BCA function, or the LKA function; whether the SCC function is canceled due to the driver controlling a brake pedal over a preset reference brake range while the SCC function is operating; or whether the LFA function is canceled due to the driver controlling steering over a preset reference steering range while the LFA function is operating.

In a vehicle of at least one embodiment of the present disclosure, the second driver driving state criterion includes at least one of: a criterion of the FCA function, the BCA function, or the LKA function to initiate warning or controlling to perform the corresponding function; a criterion of the LFA function to initiate controlling to keep a center of the lane on the road; or a criterion of the SCC function to initiate controlling to maintain a distance to a vehicle ahead.

In a vehicle of at least one embodiment of the present disclosure, the criterion of the LFA function to initiate controlling to keep the center of the lane includes one of: whether the autonomous vehicle makes a sharp turn with steering that is greater than a curvature of a straight or curved road on which the autonomous vehicle is driving; whether, while driving with steering less than a curvature of a curved road on which the autonomous vehicle is driving, the autonomous vehicle changes the steering to greater steering; or whether, although the autonomous vehicle is positioned at the center of the lane, the driver steers a number of times over a preset reference number.

In a vehicle of at least one embodiment of the present disclosure, the criterion of the SCC function to initiate controlling to maintain the distance to the vehicle ahead of the autonomous vehicle includes one of: whether a deviation of a maintained distance to the vehicle ahead is greater than a preset value; whether the autonomous vehicle decelerates with a deceleration greater than a preset value even in the absence of the vehicle ahead; or whether the autonomous vehicle decelerates with the deceleration in a situation where the distance to the vehicle ahead is greater than a preset maintained distance and there is no change in acceleration of the vehicle ahead.

In a vehicle of at least one embodiment of the present disclosure, the processor is further configured to: in response to departing from the first driver driving state criterion or the second driver driving state criterion, calculate an inattentive driving score; accumulate the calculated inattentive driving score; and apply the accumulated inattentive driving score to a plurality of preset reference risk levels to determine the driver inattention state.

In a vehicle of at least one embodiment of the present disclosure, the processor is further configured to, in response to not departing from the first driver driving state criterion or the second driver driving state criterion during a preset reference driving time, decrease the accumulated inattentive driving score by a score.

According to embodiments of the present disclosure described herein, an autonomous vehicle and its control method may accurately determine a driver inattention state using an autonomous driving function, sensors, and a processor, and may warn a driver of an appropriate timing based on a result of the determining, thereby ensuring safety.

In addition, the autonomous vehicle and its control method may accurately determine the driver inattention state by distinguishing between a case where the driver relies on or uses the autonomous driving function and a case where the driver does not use the autonomous driving function. The autonomous vehicle and its control method may make the driver aware of a result of determining the driver inattention state, thereby improving safety.

In addition, the autonomous vehicle and its control method may improve the accuracy of determining the driver inattention state by determining the driver inattention state based on a situation with a high risk of accident or a dangerous situation such as a lane departure and an imminent vehicle collision.

The effects that can be achieved from the present disclosure are not limited to those described above. Other effects not described above may also be more clearly understood by those having ordinary skill in the art from the following description.

### BRIEF DESCRIPTION OF THE DRAWINGS

FIG. 1 is a diagram illustrating an autonomous vehicle according to an embodiment of the present disclosure.

FIG. 2 is a block diagram illustrating an autonomous vehicle according to an embodiment of the present disclosure.

FIG. 3 is a diagram illustrating a method of controlling an autonomous vehicle according to an embodiment of the present disclosure.

FIGS. 4 and 5 are diagrams illustrating whether an autonomous driving function operates according to an embodiment of the present disclosure.

FIG. 6 is a diagram illustrating risk levels according to an embodiment of the present disclosure.

FIG. 7 is a diagram illustrating a display on a cluster according to an embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to the accompanying drawings. The same or similar elements are given the same reference numerals throughout the drawings, and a repeated description thereof has been omitted. Further, in describing embodiments, where it has been determined that a detailed description of related publicly known technology may have obscured the gist of the embodiments described herein, the detailed description thereof has been omitted.

As used herein, the terms “include,” “comprise,” and “have” and variations thereof specify the presence of stated features, numbers, operations, elements, components, and/or combinations thereof. Such terms do not preclude the presence or addition of one or more other features, numbers, operations, elements, components, and/or combinations thereof. In addition, when describing embodiments with reference to the accompanying drawings, like reference numerals refer to like components and a repeated description related thereto has been omitted.

In addition, the terms “unit” and “control unit” included in names such as a vehicle control unit (VCU) may be terms widely used in the naming of a control device or controller configured to control vehicle-specific functions but may not be a term that represents a generic function unit. For example, each controller or control unit may include a communication device that communicates with other controllers or sensors to control a corresponding function, a memory that stores an operating system (OS) or logic commands and input/output information, and at least one processor that performs determination, calculation, selection, and the like necessary to control the function. When a controller, module, unit, control unit, vehicle control unit, component, device, element, or the like of the present disclosure is described as having a purpose or performing an operation, function, or the like, the controller, module, unit, control unit, vehicle control unit, component, device, element, or the like should be considered herein as being “configured to” meet that purpose or to perform that operation or function. Each controller, module, unit, control unit, vehicle control unit, component, device, element, and the like may separately embody or be included with a processor and a memory, such as a non-transitory computer readable media, as part of the apparatus.

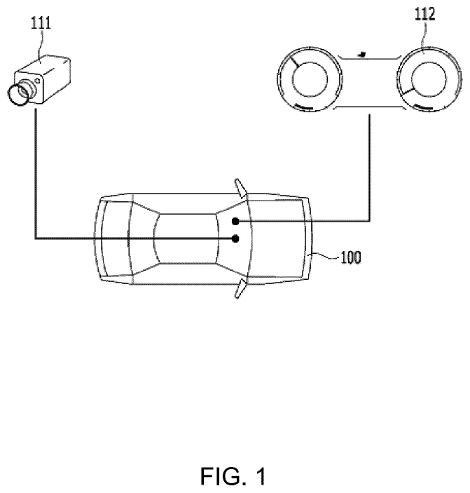

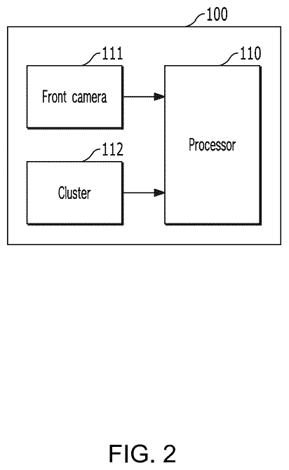

FIG. 1 is a diagram illustrating an autonomous vehicle according to an embodiment of the present disclosure. FIG. 2 is a block diagram illustrating an autonomous vehicle according to an embodiment of the present disclosure.

Referring to FIG. 1, an autonomous vehicle 100 according to an embodiment of the present disclosure may include a processor 110, a front camera 111, an instrument cluster 112, and a plurality of sensors (not shown).

The sensors may include a forward-sensing sensor disposed at the front or rear of the autonomous vehicle 100. The sensors may include, for example, a radar, a lidar, and the like.

The radar (not shown) may be mounted as one or more radars on the autonomous vehicle 100. The radar may measure a relative speed and a relative distance with respect to a recognized object, together with a wheel speed sensor (not shown) mounted on the autonomous vehicle 100.

The lidar (not shown) may be mounted as one or more lidars on the autonomous vehicle 100. The lidar may irradiate a laser pulse to an object, measure a time at which the laser pulse reflected from the object present within a measurement range returns, sense information such as a distance to the object, a direction and speed of the object, and the like, and output lidar data based on the sensed information.

The front camera 111 may be mounted as one or more cameras on the autonomous vehicle 100. The front camera 111 may capture images of objects around the autonomous vehicle 100 and their states and output image data based on the captured information.

The cluster 112 may be mounted on the autonomous vehicle 100 to display various information related to the autonomous vehicle 100 that is driving on a driving route. The cluster 112 may also be referred to as an in-vehicle display or digital cluster.

For example, the cluster 112 may provide a driver with driving-related information such as speed, fuel level, vehicle trip information, accumulated driving distance, and distance to vehicles ahead. The cluster 112 may also provide a driver with various information including, for example, forward collision-avoidance assist (FCA) information, lane keeping assist (LKA) information, blind-spot collision-avoidance assist (BCA) information, smart cruise control (SCC) information, lane following assist (LFA) information, navigation information, and the like. However, examples are not limited to the preceding examples.

The cluster 112 may also provide the driver with driving information captured by the front camera 111, which may provide a wider field of view, reduce a head rotation angle of the driver to reduce eye distraction, and increase driving comfort and safety.

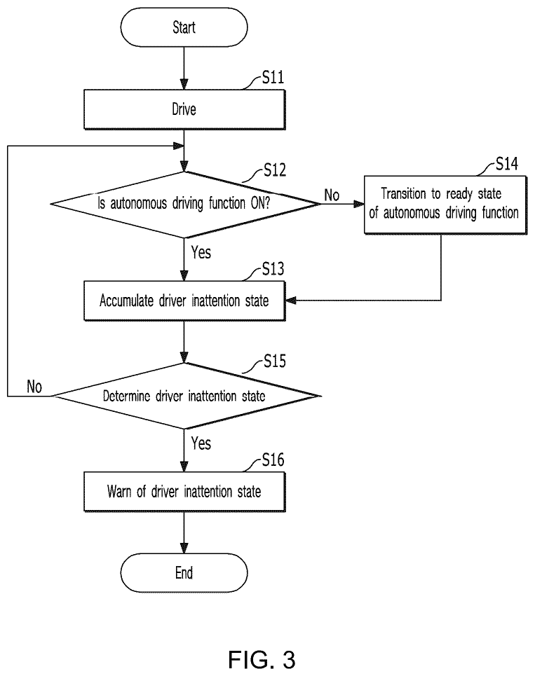

The processor 110 may control operations to sense an operation state of an autonomous driving function, e.g. whether an autonomous driving function operates, while the autonomous vehicle 100 is driving on a road, set a driver's driving state criterion differently based on a result of the sensing, determine a driver inattention state based on the set driver's driving state criterion, and display a result of the determination on the instrument cluster 112. This is described in more detail below with reference to FIGS. 3-7.

In addition, when the autonomous driving function is not in an on state, the processor 110 may control the operations to recognize a relative distance of a vehicle ahead/behind the autonomous vehicle and a distance to a lane line while maintaining the autonomous driving function in a ready state. The states of the autonomous driving function may include “on,” “off,” and “ready” states, which are described in more detail below.

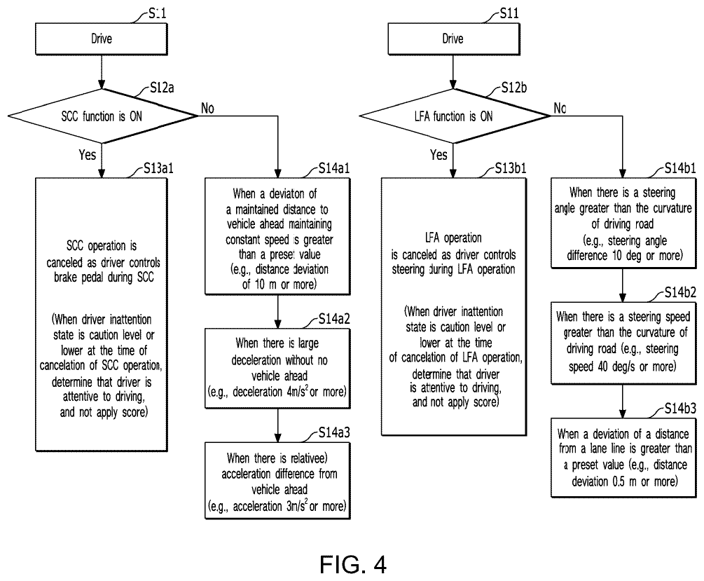

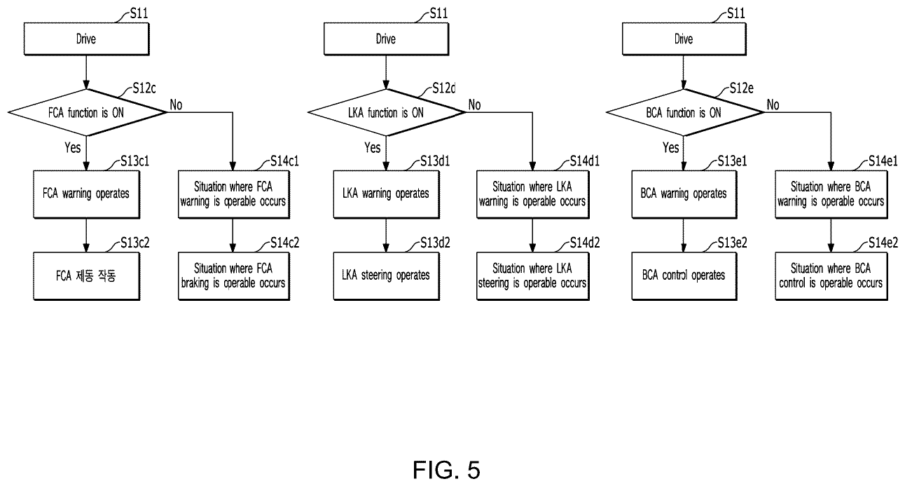

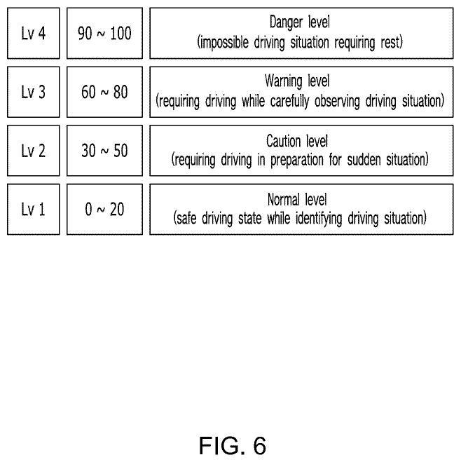

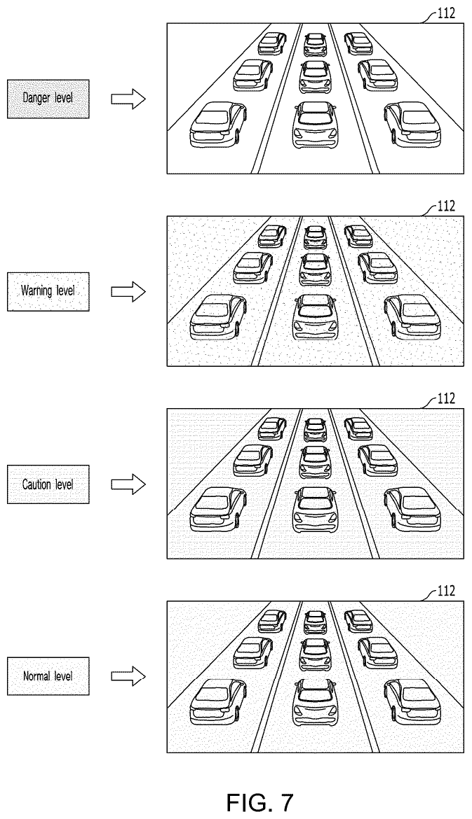

FIG. 3 is a diagram illustrating a method of controlling an autonomous vehicle according to an embodiment of the present disclosure. FIGS. 4 and 5 are diagrams illustrating in detail whether an autonomous driving function operates according to an embodiment of the present disclosure. FIG. 6 is a diagram illustrating risk levels according to an embodiment of the present disclosure. FIG. 7 is a diagram illustrating a display on an instrument cluster according to an embodiment of the present disclosure.

Referring to FIG. 3, a method of controlling the autonomous vehicle 100 according to an embodiment of the present disclosure is as follows.

In step S11, the autonomous vehicle 100 may drive on a road under the control of the processor 110.

In step S12, under the control of the processor 110, the autonomous vehicle 100 may sense whether an autonomous driving function operates while driving on the road.

In step S13, under the control of the processor 110, the autonomous vehicle 100 may set a corresponding driver's driving state criterion in a case where the autonomous driving function is in an on state and may accumulate a score for a driver inattention state based on the set driver's driving state criterion.

In this example, the “on” state of the autonomous driving function may be defined as a state in which the autonomous driving function is turned on to operate and in which both the function and the logic of the function are operational. An “off” state of the autonomous driving function may be defined as a state in which the autonomous driving function is turned off not to operate and in which both the function and the logic of the function are not operational. In addition, a “ready” state of the autonomous driving function may be defined as a state in which the autonomous driving function is turned off so as not to operate, but the logic of the function for checking whether a condition to initiate warning or controlling to perform the function is satisfied based on the criterion thereof is operational.

The autonomous driving function may include, as non-limiting examples, a forward collision-avoidance assist (FCA) function, a lane keeping assist (LKA) function, a blind-spot collision-avoidance assist (BCA) function, a smart cruise control (SCC) function, and a lane following assist (LFA) function.

In step S14, when the autonomous driving function is not in the on state, the autonomous vehicle 100 may transition the autonomous driving function to the ready state, under the control of the processor 110. For example, when the autonomous driving function is not in the on state, the autonomous vehicle 100 may recognize a relative distance of a vehicle ahead/behind and a distance to a lane while maintaining the autonomous driving function in the ready state, under the control of the processor 110. In this case, the ready state of the autonomous driving function may be a state in which the autonomous driving function is not operating, but the logic of the autonomous driving function is driven to determine whether conditions for warning or control are satisfied, under the control of the processor 110.

In other words, under the control of the processor 110, the autonomous vehicle 100 may set the corresponding driver's driving state criterion when the autonomous driving function is not in the on state and may accumulate a score for the driver inattention state based on the set driver's driving state criterion in step S13. The score for the driver inattention state may also be referred to herein as an inattentive driving score.

The driver's driving state criterion may include a first driver driving state criterion and a second driver driving state criterion.

For example, when the autonomous driving function is in the on state, the autonomous vehicle 100 may set the driver's driving state criterion to the first driver driving state criterion under the control of the processor 110. In contrast, when the autonomous driving function is not in the on state, the autonomous vehicle 100 may set the driver's driving state criterion to the second driver driving state criterion under the control of the processor 110.

The first driver driving state criterion may be, for example, at least one of the following examples. The first driver driving state criterion may be whether there is a warning or control by the FCA function, the BCA function, or the LKA function due to a movement direction or speed of the autonomous vehicle 100 being changed by the driver to depart from a preset reference range, while the FCA function, the BCA function, or the LKA function is operating. The first driver driving state criterion may be whether the SCC function is canceled due to the driver controlling a brake pedal over a preset reference brake range while the SCC function is operating. The first driver driving state criterion may be whether the LFA function is canceled due to the driver controlling steering over a preset reference steering range while the LFA function is operating. However, examples are not limited to the preceding.

The second driver driving state criterion may include, for example, at least one of the following examples. The second driver driving state criterion may include a criterion of the FCA function, the BCA function, or the LKA function to initiate warning or controlling to perform the corresponding function. The second driver driving state criterion may include a criterion of the LFA function to initiate controlling to keep a center of a lane on the road. The second driver driving state criterion may include a criterion of the SCC function to initiate controlling to maintain a distance to a vehicle ahead. However, examples are not limited to the preceding.

As described above, under the control of the processor 110, the autonomous vehicle 100 may calculate an inattentive driving score in response to departing from the first driver driving state criterion or the second driver driving state criterion. The autonomous vehicle 100 may accumulate the calculated inattentive driving score.

Subsequently, in step S15, under the control of the processor 110, the autonomous vehicle 100 may determine a driver inattention state based on the accumulated inattentive driving score. For example, under the control of the processor 110, the autonomous vehicle 100 may determine the driver inattention state by applying the accumulated inattentive driving score to a plurality of preset reference risk levels. The reference risk levels are to be described in more detail below.

Subsequently, under the control of the processor 110, the autonomous vehicle 100 may display, on the cluster, a determination result based on the determined driver inattention state. In this case, under the control of the processor 110, the autonomous vehicle 100 may display the result of determining the driver inattention state on the cluster to warn the driver of this in a timely and accurate manner in step S16.

FIGS. 4 and 5 are diagrams illustrating in detail whether an autonomous driving function operates according to an embodiment of the present disclosure.

As shown in FIG. 4, in steps S12a and S12b, under the control of the processor 110, the autonomous vehicle 100 may sense whether the SCC function and the LFA function of the autonomous driving function are operating.

When the SCC function is in the on state (Yes in S12a), the autonomous vehicle 100 may determine that the driver is driving in reliance on the autonomous driving function, under the control of the processor 110.

For example, in step S13a1, when the driver controls a brake pedal while the SCC function is operating, the autonomous vehicle 100 may determine a departure from the first driver driving state criterion as the operation of the SCC function is canceled and may calculate an inattentive driving score, under the control of the processor 110.

As described above, the autonomous vehicle 100 may continue to accumulate the calculated inattentive driving score for a preset time or interval, under the control of the processor 110. Alternatively, when a driver inattention state at the time of the cancelation of the operation of the SCC function corresponds to a caution level or lower among the reference risk levels, the autonomous vehicle 100 may determine that the driver is attentive to driving, under the control of the processor 110. In this case, the processor 110 may not apply the calculated inattentive driving wdo43 in step S13a1, exceptionally. This is described in more detail below.

When the SCC function is not in the on state (No in S12a), the autonomous vehicle 100 may determine that the driver is driving without relying on the autonomous driving function, under the control of the processor 110.

In steps S14a1, S14a2, and S14a3, when a distance to a vehicle ahead deviates while being controlled to be maintained, while the SCC function is in the ready state, the autonomous vehicle 100 may determine a departure from the second driver driving state criterion and may calculate an inattentive driving score, under the control of the processor 110.

For example, under the control of the processor 110, the autonomous vehicle 100 may determine a departure from the second driver driving state criterion in at least one of the following cases. In case S14a1, a deviation of a maintained distance to the vehicle ahead is greater than a preset value while the distance to the vehicle ahead is maintained in the ready state of the SCC function. In case S14a2, the vehicle is decelerating with a deceleration greater than a preset value even when there is no vehicle ahead. In case S14a3, the vehicle is decelerating with the deceleration in a situation where the distance to the vehicle ahead is greater than a preset maintained distance and there is no change in acceleration of the vehicle ahead. The autonomous vehicle 100 may then calculate an inattentive driving score.

For example, in step S14a1, when a deviation of a maintained distance to a vehicle ahead that travels at a constant speed is greater than or equal to 10 meters (m), the autonomous vehicle 100 may determine a departure from the second driver driving state criterion and calculate an inattentive driving score, under the control of the processor 110. Alternatively, in step S14a2, when decelerating at a speed greater than a preset speed of 4 m/s² in the absence of a vehicle ahead, the autonomous vehicle 100 may determine a departure from the second driver driving state criterion and calculate an inattentive driving score, under the control of the processor 110. Alternatively, in step S14a3, when a relative acceleration difference from a vehicle ahead is 3 m/s² or more, the autonomous vehicle 100 may determine a departure from the second driver driving state criterion and calculate an inattentive driving score, under the control of the processor 110.

As described above, under the control of the processor 110, the autonomous vehicle 100 may continue to accumulate the calculated inattentive driving score for a preset time or interval.

In addition, when the LFA function is in the on state (Yes in S12b), the autonomous vehicle 100 may determine that the driver is driving in reliance on the autonomous driving function, under the control of the processor 110.

For example, in step S13b1, when the driver controls steering while the LFA function is operating, the autonomous vehicle 100 may determine a departure from the first driver driving state criterion as the LFA function is canceled and then may calculate an inattentive driving score, under the control of the processor 110.

As described above, under the control of the processor 110, the autonomous vehicle 100 may continue to accumulate the calculated inattentive driving score for a preset time or interval. Alternatively, when the driver inattention state at the time of the cancelation of the operation of the LFA function corresponds to the caution level or lower among the reference risk levels, the autonomous vehicle 100 may determine that the driver is attentive to driving, under the control of the processor 110. In this case, the processor 110 may not apply the calculated inattentive driving score in step S13b1, exceptionally. This is described in more detail below.

When the LFA function is not in the on sate (No in S13b1), the autonomous vehicle 100 may determine that the driver is driving without relying on the autonomous driving function, under the control of the processor 110.

In steps S14b1, S14b2, and S14b3, when a center of a lane deviates while being controlled to be maintained, while the LFA function is in the ready sate, the autonomous vehicle 100 may determine a departure from the second driver driving state criterion and calculate an inattentive driving score, under the control of the processor 110.

For example, under the control of the processor 110, the autonomous vehicle 100 may determine that it is in a condition corresponding to the second driver driving state criterion in at least one of the following cases. In case S14b1, the autonomous vehicle 100 makes a sharp turn with steering that is greater than the curvature of a straight/curved road on which the autonomous vehicle 100 is driving, while the center of the lane is being maintained in the ready state of the LFA function. In case S14b2, while driving with steering less than a curvature of a curved road on which the autonomous vehicle 100 is driving, the autonomous vehicle 100 changes the steering to greater steering. In case S14b3, although the autonomous vehicle 100 is positioned at the center of the lane, the driver steers over a preset reference number of times and may then calculate an inattentive driving score. In other words, each of the above cases may be a criterion for the second driver driving state criterion.

For example, in step S14b1, when a steering angle is greater than the curvature of the driving road, for example, when a steering angle difference is 10 degrees (deg) or more, the autonomous vehicle 100 may determine a departure from the second driver driving state criterion and calculate an inattentive driving score, under the control of the processor 110. Alternatively, in step S14b2, when a steering speed is greater than the curvature of the driving road, for example, when the steering speed is 4 deg/s or more, the autonomous vehicle 100 may determine a departure from the second driver driving state criterion and calculate an inattentive driving score, under the control of the processor 110. Alternatively, in step S14b3, when a distance deviation from the lane is large, for example, when the distance deviation is 0.5 meters (m) or more, the autonomous vehicle 100 may determine a departure from the second driver driving state criterion and calculate an inattentive driving score, under the control of the processor 110.

As described above, under the control of the processor 110, the autonomous vehicle 100 may continue to accumulate the calculated inattentive driving score for a preset time or interval.

As shown in FIG. 5, in steps S12c, S12d, and S12e, under the control of the processor 110, the autonomous vehicle 100 may sense whether the FCA, BCA, and LKA functions of the autonomous driving function are operating.

When the FCA function is in the on state (Yes in S12c), the autonomous vehicle 100 may determine that the driver is driving in reliance on the autonomous driving function, under the control of the processor 110.

For example, when an FCA warning function (e.g., S13cl) or an FCA control function (e.g., S13c2) operates as the driver controls, at will, a movement direction and speed of the autonomous vehicle 100 while the FCA function is operating, the autonomous vehicle 100 may determine a departure from the first driver driving state criterion while canceling the operation of the FCA function and may calculate an inattentive driving score, under the control of the processor 110.

When the FCA function is not in the on state (No in S12c), the autonomous vehicle 100 may determine that the driver is driving without relying on the autonomous driving function, under the control of the processor 110.

While the FCA function is in the ready state, in a case S14cl where the FCA warning function is operable or in a case S14c2 where the FCA control function is operable, the autonomous vehicle 100 may determine a departure from the second driver driving state criterion and may calculate an inattentive driving score, under the control of the processor 110.

As described above, the autonomous vehicle 100 may continue to accumulate the calculated inattentive driving score for a preset time or interval, under the control of the processor 110.

In addition, when BCA function is in the on state (Yes in S12d), the autonomous vehicle 100 may determine that driver is driving in reliance on the autonomous driving function, under the control of the processor 110.

For example, when a BCA warning function (e.g., S13dl) or a BCA control function (e.g., S13d2) operates as the driver controls, at will, a movement direction and speed of the autonomous vehicle 100 while the BCA function is operating, the autonomous vehicle 100 may determine a departure from the first driver driving state criterion while canceling the operation of the BCA function and may calculate an inattentive driving score, under the control of the processor 110.

When BCA function is not in the on state (No in S12d), the autonomous vehicle 100 may determine that the driver is driving without relying on the autonomous driving function, under the control of the processor 110.

While the BCA function is in the ready state, in a case S14d1 where the BCA warning function is operable or in a case S14d2 where the BCA control function is operable, the autonomous vehicle 100 may determine a departure from the second driver driving state criterion and may calculate an inattentive driving score, under the control of the processor 110.

As described above, under the control of the processor 110, the autonomous vehicle 100 may continue to accumulate the calculated inattentive driving score for a preset time or interval.

In addition, when the LKA function is in the on state (Yes in S12e), the autonomous vehicle 100 may determine that the driver is driving in reliance on the autonomous driving function, under the control of the processor 110.

For example, when an LKA warning function (e.g., S13e1) or an LKA control function (e.g., S13e2) operates as the driver controls, at will, a movement direction and speed of the autonomous vehicle 100 while the LKA function is operating, the autonomous vehicle 100 may determine a departure from the first driver driving state criterion while canceling the operation of the LKA function and may calculate an inattentive driving score, under the control of the processor 110.

When the LKA function is not in the on state (No in S12e), the autonomous vehicle 100 may determine that the driver is driving without relying on the autonomous driving function, under the control of the processor 110.

While the LKA function is in the ready state, in a case S14e1 where the LKA warning function is operable or in a case S14e2 where the LKA control function is operable, the autonomous vehicle 100 may determine a departure from the second driver driving state criterion and may calculate an inattentive driving score, under the control of the processor 110.

As described above, the autonomous vehicle 100 may continue to accumulate the calculated inattentive driving score for a preset time or interval, under the control of the processor 110.

Referring to FIG. 6, under the control of the processor 110, the autonomous vehicle 100 may accumulate a calculated inattentive driving score and may apply the accumulated inattentive driving score to a plurality of preset reference risk levels to determine a driver inattention state.

For example, under the control of the processor 110, the autonomous vehicle 100 may calculate the inattentive driving score using the same IGN cycle accumulation method. For example, the inattentive driving score may be calculated to be 10 points for one warning and 20 points for one control. For example, the inattentive driving score may be calculated to be 10 points for each of SCC and LFA functions.

In addition, there may be one or more reference risk levels. For example, the reference risk levels may include first (Lv1) to fourth (Lv4) reference risk levels.

The first reference risk level Lv1 may correspond to the accumulated inattentive driving score of 20 points or less. The first reference risk level Lv1 may be a normal level where the driver is aware of a driving situation and is driving safely.

The second reference risk level Lv2 may correspond to the accumulated inattentive driving score of 30 points or more and 50 points or less. The second reference risk level Lv2 may be a caution level that requires driving in preparation for a sudden situation or emergency.

The third reference risk level Lv3 may correspond to the accumulated inattentive driving score of 60 points or more and 80 points or less. The third reference risk level Lv3 may be a warning level that requires driving while carefully observing a driving situation.

The fourth reference risk level Lv4 may correspond to the accumulated inattentive driving score of 90 points or more and 100 points or less. The fourth reference risk level Lv4 may be a danger level that requires a rest with driving impossible.

In contrast, when there is no departure from the first driver driving state criterion or the second driver driving state criterion during a preset reference driving time or during a preset reference driving interval, the autonomous vehicle 100 may decrease the accumulated inattentive driving score by a score, under the control of the processor 110.

For example, under the control of the processor 110, while calculating the inattentive driving score using the same IGN cycle accumulation method, the autonomous vehicle 100 may decrease the accumulated inattentive driving score by 10 points when there is no additional score during the preset driving time.

For example, under the control of the processor 110, the autonomous vehicle 100 may decrease the accumulated inattentive driving score by 10 points every 10 minutes for which no additional points are accrued.

In addition, the autonomous vehicle 100 may display, through an instrument cluster, a result of determining the driver inattention state, under the control of the processor 110.

As shown in FIG. 7, the autonomous vehicle 100 may display the cluster differently based on a plurality of reference risk levels, under the control of the processor 110.

For example, under the control of the processor 110, the autonomous vehicle 100 may display the cluster in green when the driver inattention state is determined to be at a normal level, which is the first reference risk level Lv1.

Alternatively, under the control of the processor 110, the autonomous vehicle 100 may display the cluster in blue when the driver inattention state is determined to be at a caution level, which is the second reference risk level Lv2.

Alternatively, under the control of the processor 110, the autonomous vehicle 100 may display the cluster in yellow when the driver inattention state is determined to be at a warning level, which is the third reference risk level Lv3.

Alternatively, under the control of the processor 110, the autonomous vehicle 100 may display the cluster in red when the driver inattention state is determined to be at a danger level, which is the fourth reference risk level Lv4.

However, examples are not limited to the preceding, and the cluster may be displayed in various colors. Alternatively, the processor 110 may output warning sounds, messages, blinks, and the like according to the plurality of reference risk levels, along with the cluster.

As described above, an autonomous vehicle and its control method according to embodiments of the present disclosure may accurately determine an inattentive driving state of a driver using an autonomous driving function, sensors, and a processor, and may warn the driver of a determination result in a timely manner.

Further, the autonomous vehicle and the control method may accurately determine the inattentive driving state of the driver by distinguishing between cases where the driver relies on or uses the autonomous driving function and cases where the driver does not use the autonomous driving function and may make the driver aware of a determination result.

Furthermore, the autonomous vehicle and the control method may improve the accuracy of determining the inattentive driving state of the driver by determining the inattentive driving state based on a situation where a risk of accident is high or a dangerous situation such as a lane departure and an imminent vehicle collision.

The embodiments of the present disclosure described herein may be implemented as computer-readable code on a medium in which a program is recorded. The computer-readable medium may include all types of recording devices that store data to be read by a computer system. The computer-readable medium may include, for example, a hard disk drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, and the like.

Accordingly, the preceding detailed description should not be construed as restrictive but as illustrative in all respects. The scope of the embodiments of the present disclosure should be determined by reasonable interpretation of the appended claims. All changes and modifications within the equivalent scope of the present disclosure are included in the scope of the present disclosure.

What is claimed is:

1. A method of controlling an autonomous vehicle having a processor, the method comprising, under control of the processor:
sensing an operation state of an autonomous driving function;
setting a driver's driving state criterion based on a result of the sensing;
determining a driver inattention state based on the driver's driving state criterion; and
displaying, on an instrument cluster, a result of determining the driver inattention state.

2. The method of claim 1, further comprising, under the control of the processor:
in response to the autonomous driving function not being in an on state, recognizing a relative distance to a front vehicle travelling ahead of the autonomous vehicle or to a vehicle travelling behind the autonomous vehicle in another lane and recognizing a distance to a lane line while maintaining the autonomous driving function in a ready state.

3. The method of claim 2, wherein setting the driver's driving state criterion comprises:
in response to the autonomous driving function being in the on state, setting the driver's driving state criterion to a first driver driving state criterion; or
in response to the autonomous driving function not being in the on state, setting the driver's driving state criterion to a second driver driving state criterion.

4. The method of claim 3, wherein:
the autonomous driving function comprises a forward collision-avoidance assist (FCA) function, a lane keeping assist (LKA) function, a blind-spot collision-avoidance assist (BCA) function, a smart cruise control (SCC) function, or a lane following assist (LFA) function; and
wherein the first driver driving state criterion includes at least one of
whether a warning or control occurs by the FCA function, the BCA function, or the LKA function due to a driver changing a movement direction or speed of the autonomous vehicle while the FCA function, the BCA function, or the LKA function is operating,
whether the SCC function is canceled due to the driver controlling a brake pedal over a preset reference brake range while the SCC function is operating, or
whether the LFA function is canceled due to the driver controlling steering over a preset reference steering range while the LFA function is operating.

5. The method of claim 4, wherein the second driver driving state criterion includes at least one of:
a criterion of the FCA function, the BCA function, or the LKA function to initiate warning or controlling to perform a corresponding function;
a criterion of the LFA function to initiate controlling to keep a center of the lane on a road; or
a criterion of the SCC function to initiate controlling to maintain a distance to a vehicle ahead.

6. The method of claim 5, wherein the criterion of the LFA function to initiate controlling to keep the center of the lane comprises one of:
whether the autonomous vehicle makes a sharp turn with steering that is greater than a curvature of a straight or curved road on which the autonomous vehicle is driving;
whether, while driving with steering less than a curvature of a curved road on which the autonomous vehicle is driving, the autonomous vehicle changes the steering to greater steering; or
whether, although the autonomous vehicle is positioned at the center of the lane, the driver steers a number of times over a preset reference number.

7. The method of claim 5, wherein the criterion of the SCC function to initiate controlling to maintain the distance to the vehicle ahead of the autonomous vehicle comprises one of:
whether a deviation of a maintained distance to the vehicle ahead is greater than a preset value;
whether the autonomous vehicle decelerates with a deceleration greater than a preset value even in the absence of the vehicle ahead; or
whether the autonomous vehicle decelerates with the deceleration in a situation where the distance to the vehicle ahead is greater than a preset maintained distance and there is no change in acceleration of the vehicle ahead.

8. The method of claim 7, wherein determining the driver inattention state comprises, under the control of the processor:
in response to departing from the first driver driving state criterion or the second driver driving state criterion, calculating an inattentive driving score;
accumulating the calculated inattentive driving score; and
applying the accumulated inattentive driving score to a plurality of preset reference risk levels to determine the driver inattention state.

9. The method of claim 8, wherein determining the driver inattention state further comprises, under the control of the processor:
in response to not departing from the first driver driving state criterion or the second driver driving state criterion during a preset reference driving time, decreasing by a score from the accumulated inattentive driving score.

10. A non-transitory computer-readable storage medium storing instructions that are executable by a processor to perform:
sensing an operation state of an autonomous driving function;
setting a driver's driving state criterion based on a result of the sensing;
determining a driver inattention state based on the driver's driving state criterion; and
displaying, on an instrument cluster, a result of the determining.

11. An autonomous vehicle comprising a processor, wherein the processor is configured to:
sense an operation state of an autonomous driving function;
set a driver's driving state criterion based on a result of the sensing;
determine a driver inattention state based on the set driver's driving state criterion; and
display, on an instrument cluster, a result of the determining.

12. The autonomous vehicle of claim 11, wherein the processor is further configured to:
when the autonomous driving function is not in an on state, recognize a relative distance to a front vehicle travelling ahead of the autonomous vehicle or a vehicle travelling behind the autonomous vehicle in another lane and to recognize a distance to a lane line while maintaining the autonomous driving function in a ready state.

13. The autonomous vehicle of claim 12, wherein the processor is further configured to:
in response to the autonomous driving function being in the on state, set the driver's driving state criterion to a first driver driving state criterion; or
in response to the autonomous driving function not being in the on state, set the driver's driving state criterion to a second driver driving state criterion.

14. The autonomous vehicle of claim 13, wherein:
the autonomous driving function comprises a forward collision-avoidance assist (FCA) function, a lane keeping assist (LKA) function, a blind-spot collision-avoidance assist (BCA) function, a smart cruise control (SCC) function, or a lane following assist (LFA) function; and
wherein the first driver driving state criterion includes one of
whether a warning or control occurs by the FCA function, the BCA function, or the LKA function due to the driver changing a movement direction or speed of the autonomous vehicle while the FCA function, the BCA function, or the LKA function,
whether the SCC function is canceled due to the driver controlling a brake pedal over a preset reference brake range while the SCC function is operating, or
whether the LFA function is canceled due to the driver controlling steering over a preset reference steering range while the LFA function is operating.

15. The autonomous vehicle of claim 14, wherein the second driver driving state criterion includes at least one of:
a criterion of the FCA function, the BCA function, or the LKA function to initiate warning or controlling to perform a corresponding function;
a criterion of the LFA function to initiate controlling to keep a center of the lane on a road; or
a criterion of the SCC function to initiate controlling to maintain a distance to a vehicle ahead.

16. The autonomous vehicle of claim 15, wherein the criterion of the LFA function to initiate controlling to keep the center of the lane comprises one of:
whether the autonomous vehicle makes a sharp turn with steering that is greater than a curvature of a straight or curved road on which the autonomous vehicle is driving;
whether, while driving with steering less than a curvature of a curved road on which the autonomous vehicle is driving, the autonomous vehicle changes the steering to greater steering; or
whether, although the autonomous vehicle is positioned at the center of the lane, the driver steers a number of times over a preset reference number.

17. The autonomous vehicle of claim 15, wherein the criterion of the SCC function to initiate controlling to maintain the distance to the vehicle ahead comprises one of:
whether a deviation of a maintained distance to the vehicle ahead is greater than a preset value;
whether the autonomous vehicle decelerates with a deceleration greater than a preset value even in the absence of the vehicle ahead; or
whether the autonomous vehicle decelerates with the deceleration in a situation where the distance to the vehicle ahead is greater than a preset maintained distance and there is no change in acceleration of the vehicle ahead.

18. The autonomous vehicle of claim 17, wherein the processor is further configured to:
in response to departing from the first driver driving state criterion or the second driver driving state criterion, calculate an inattentive driving score;
accumulate the calculated inattentive driving score; and
apply the accumulated inattentive driving score to a plurality of preset reference risk levels to determine the driver inattention state.

19. The autonomous vehicle of claim 18, wherein the processor is further configured to:
in response to not departing from the first driver driving state criterion or the second driver driving state criterion during a preset reference driving time, decrease the accumulated inattentive driving score by a score
